(19) United States
(12) Patent Application Publication
(10) Pub. No.: US 2004/0210353 A1
(43) Pub. Date: Oct. 21, 2004

(54) Vehicle driver quality determination method and system

(76) Inventor: Kevin Joseph Rice, Galway (IE)

Correspondence Address: SUGHRUE MION, PLLC, 2100 PENNSYLVANIA AVENUE, N.W., SUITE 800, WASHINGTON, DC, 20037, US

(21) Appl. No.: 10/475,448

(22) PCT Filed: Apr. 22, 2002
(86) PCT No.: PCT/IE02/00051

(30) Foreign Application Priority Data
Apr. 20, 2001 (EP) 01109753.2

(51) Int. Cl. G06F 17/00

(52) U.S. Cl. 701/1; 701/93; 701/35

(57) ABSTRACT

A method and apparatus (1,2) for monitoring movement of a vehicle in order to permit a determination of the quality of driving of the driver of the vehicle to be made. The method and apparatus (1,2) monitors the movement of a vehicle at monitoring intervals typically of ten seconds duration. The date, time, location and speed of the vehicle at the end of each monitoring interval is recorded and stored. The location and speed of the vehicle is determined from the GPS system. A server (2) in a central monitoring station downloads the stored dates, times, locations and speed of the vehicle as well as the distance travelled by the vehicle, which is then tabulated and the number of speed infringements in the respective different speed limit zones are computed. The driver is then given a ranking score which is computed from the number of infringements in the respective speed zones and the infringements are weighted, the higher weightings being assigned to infringements in the higher speed zones, and weighting is also given to infringements depending on the amount by which the speed limit in the respective speed zones has been exceeded. The ranking score of the driver allows an insurance company to determine the quality of driving of the driver and thus set an insurance premium appropriately for the driver.

The present invention relates to a method and apparatus for monitoring movement of a vehicle and for determining quality of driving of a driver driving the vehicle.

Because of their alleged high accident rate, insurance companies tend to significantly load the premiums for motor vehicle insurance for young drivers, and in particular, young male drivers in the age range 17 to 25. While some young male drivers may not drive with the appropriate degree of care and consideration for other road users, nonetheless many such young drivers are particularly careful drivers and considerate to other road users. However, unfortunately, there are no suitable methods or apparatus for determining which drivers drive carefully and with the appropriate degree of consideration for other road users, and which drivers do not. Thus, because of this, insurance companies have little option but to charge all young drivers, and in particular, young male drivers between the ages of 17 and 25 an insurance premium which is significantly higher than that charged to older, more mature drivers.

PCT Patent Specification No. WO 01/18766 discloses a road vehicle speed restriction violation system which comprises an apparatus for mounting on-board on a road vehicle which determines speed of the road vehicle. On the apparatus determining that the speed of the vehicle is exceeding the maximum allowed speed of the speed limit zone in which the vehicle is travelling, a signal is transmitted from the apparatus on-board the vehicle to a central station. The central station identifies the vehicle and the infringement of the maximum allowed speed of the speed limit zone from the signal received from the vehicle. The central station then issues a speeding summons which is directed to the registered owner of the vehicle. However, this road vehicle speed restriction violation system is suitable only for entrapping speeding motorists.

European Patent Specification No. EP-A-0,592,166 discloses a tachograph for a vehicle which determines and records the location of a vehicle with time as well as other information relating to the operation of the vehicle. While the tachograph of this European specification records some data on the movement of the vehicle, it is not suitable for determining the quality of driving of a driver of a vehicle.

There is therefore a need for a method and apparatus for facilitating an insurance companies or other body to differentiate between drivers who drive carefully and with due care and consideration for other road users, and those who do not.

The present invention is directed towards a method and apparatus for monitoring movement of a vehicle, and also for determining the quality of driving of a driver of the vehicle.

According to the invention there is provided a method for monitoring movement of a vehicle, the method comprising the steps of determining the location of the vehicle at predetermined monitoring intervals, and determining the speed of the vehicle at each monitoring interval, wherein at least some of the determined speeds of the vehicle are stored and cross-referenced with the corresponding locations, maximum allowed speeds are determined for the respective locations for which vehicle speeds are stored, the stored vehicle speeds are compared with the corresponding maximum allowed speeds for the respective locations, and an infringement is recorded and stored and cross-referenced with each location at which the vehicle speed exceeded the maximum allowed speed.

In one embodiment of the invention the time at which each monitoring of the vehicle is carried out is stored. Preferably, each location of the vehicle at which the vehicle is monitored is stored and cross-referenced with the corresponding stored time at which the vehicle is monitored. Advantageously, the distance travelled by the vehicle during each monitoring interval is determined and stored and cross-referenced with the corresponding stored time corresponding to the end of the monitoring interval.

In another embodiment of the invention the beginning and end of each journey of the motor vehicle is identified, and the cumulative distance travelled by the vehicle during each journey is determined and stored. Preferably, the time taken for each journey is determined and stored. Advantageously, the time which is stored and cross-referenced with the locations of the vehicle includes the relevant date.

Ideally, the vehicle is monitored for a monitoring period. Preferably, the vehicle is monitored for a monitoring period of predetermined time.

In one embodiment of the invention the predetermined monitoring intervals are monitoring intervals of predetermined time.

In another embodiment of the invention each determined value of vehicle speed is compared with a reference minimum speed value, and only those vehicle speed values which exceed the reference minimum speed value are stored.

Preferably, the reference minimum speed value is the lowest value of maximum allowed speeds in respective speed limit zones of a jurisdiction in which the movement of the vehicle is being monitored.

In one embodiment of the invention the vehicle speed in excess of the maximum allowed speed for each location for which an infringement is recorded is determined and stored. Preferably, the maximum excess speed over the maximum allowed speed for each speed limit zone is determined and stored. Advantageously, the average excess speed over the maximum allowed speed for each speed limit zone is determined and stored and cross-referenced with the corresponding speed limit zone.

In one embodiment of the invention the number of times the vehicle is monitored during the monitoring period is determined and stored. Preferably, the number of infringements as a ratio of the number of times the vehicle is monitored is determined and stored. Advantageously, the number of infringements in each speed limit zone as a ratio of the number of times the vehicle is monitored in the corresponding speed limit zone is determined and stored.

In one embodiment of the invention a score for ranking the quality of driving of the driver of the vehicle is computed as a function of the number of infringements recorded, and the computed score stored. Advantageously, at least some of the infringements are weighted for determining the score. Preferably, the weighted infringements are weighted based on the value of the vehicle speed in excess of the corresponding maximum allowed speed. Advantageously, the greater the value of the vehicle speed in excess of the corresponding maximum allowed speed the less favourable is the weighting applied to the infringement. Preferably, the weighted infringements are weighted based on the average value of the vehicle speeds in excess of the corresponding maximum allowed speed.

Ideally, the higher the average vehicle speed in excess of the corresponding maximum allowed speed, the less favourable is the weighting applied to the infringement.

In one embodiment of the invention infringements in speed limit zones of higher the maximum allowed speeds are weighted less favourably than infringements in speed limit zones of lower maximum allowed speeds. Preferably, the weighted infringements are weighted on the basis of the number of infringements as a ratio of the number of times the vehicle is monitored. Advantageously, the higher the ratio of infringements to the number of times the vehicle is monitored, the less favourable is the weighting attached to the corresponding infringement.

In one embodiment of the invention a report on the quality of the driving of the driver of the vehicle is generated. Preferably, the report is generated at the end of each monitoring period. Advantageously, the report comprises particulars of the driver driving the vehicle, particulars of the vehicle, and the driver's score. Preferably, the report comprises particulars of the number of times the vehicle is monitored during the monitoring period and the number of infringements. Advantageously, the report comprises the total mileage travelled by the vehicle during the monitoring period of the vehicle.

In another embodiment of the invention the report contains the number of journeys made by the vehicle during the monitoring period. Preferably, the report contains the total time during which the vehicle was being driven during the monitoring period. Advantageously, the report contains the number of times the vehicle was monitored in each speed limit zone and the corresponding number of infringements in the respective speed limit zones.

In another embodiment of the invention the report contains a value of the number of infringements expressed as a ratio of the number of times the vehicle was monitored in each of the speed limit zones.

In a further embodiment of the invention the report contains the maximum excess speed over the maximum allowed speed for each speed limit zone.

In a still further embodiment of the invention the report contains the average excess speed over which the vehicle exceeded the maximum allowed speed for each speed limit zone.

In one embodiment of the invention the report contains the number of times the vehicle was monitored in each speed limit zone as a ratio of the total number of times the vehicle was monitored during the monitoring period.

In a further embodiment of the invention the times at which the vehicle is determined as moving is compared with a reference time period during which the vehicle should not be moving, and a record of movements of the vehicle during time periods during which the vehicle should not be moving is contained in the report.

In one embodiment of the invention the location and speed of the vehicle are determined by a computing means located in the vehicle and are stored in a storing means located in the vehicle for subsequent transmission to a central monitoring station. Preferably, the comparison of the vehicle speed with the reference minimum speed value is carried out in the computing means in the vehicle. Advantageously, the comparisons of the vehicle speeds with the corresponding maximum allowed speeds of the respective speed limit zones are made by a computing means at the central monitoring station. Advantageously, the stored data in the storing means in the vehicle is transmitted to the central monitoring station at the end of each monitoring period.

In one embodiment of the invention the data stored in the storing means in the vehicle is downloaded to the central monitoring station in response to an interrogation signal transmitted to the vehicle from the central monitoring station. Advantageously, the interrogation signal is transmitted by the central monitoring station at the end of each monitoring period.

In another embodiment of the invention a map of the jurisdiction in which the vehicle is being monitored is stored in the central monitoring station, the map having areas of speed limit zones of different maximum allowed speeds identified thereon, and the maximum allowed speed of each determined location is determined by looking up the map. Advantageously, the speed zones are defined by boundaries, and a plurality of longitude and latitude co-ordinates defining each boundary are stored.

In one embodiment of the invention the maximum allowed speed of each determined location is determined by comparing the determined location with the stored longitude and latitude co-ordinates of the boundaries of the respective speed limit zones on the map for determining the speed limit zone within which the determined location is located.

Preferably, the map is electronically stored.

In one embodiment of the invention the location of the vehicle is determined from a GPS monitoring system. Preferably, each determined location of the vehicle is determined by its longitude and latitude co-ordinates. Advantageously, each determined location of the vehicle is stored by storing its corresponding longitude and latitude co-ordinates.

Preferably, the speed of the vehicle is determined from a GPS system.

Advantageously, the distance travelled by the vehicle during each monitoring interval is computed by computing the average speed of the vehicle at the beginning and at the end of the corresponding monitoring interval, and multiplying the computed average speed by the time of the monitoring interval.

In one embodiment of the invention the particulars of movement of the vehicle are stored electronically.

Additionally, the invention provides apparatus for monitoring movement of a vehicle, the apparatus comprising a means for determining the location of the vehicle at predetermined monitoring intervals, and a means for determining the speed of the vehicle at each monitoring interval, characterised in that, the apparatus comprises a means for storing at least some of the determined speeds of the vehicle and for cross-referencing the vehicle speeds with the corresponding locations, a means for determining maximum allowed speeds for the respective locations for which vehicle speeds are stored, a means for comparing the stored vehicle speeds with the corresponding maximum allowed speeds for the respective locations, and a means for recording and storing an infringement and for cross-referencing the infringement with each corresponding location at which the vehicle speed exceeded the maximum allowed speed.

In one embodiment of the invention a means for storing the times at which the vehicle is monitored is provided. Preferably, a means for storing each location of the vehicle at which the vehicle is monitored and cross-referenced with the corresponding stored time at which the vehicle was monitored is provided. Advantageously, a means is provided for determining and storing the distance travelled by the vehicle during each monitoring interval cross-referenced with the corresponding stored time corresponding to the end of the monitoring interval.

In one embodiment of the invention a means is provided for identifying the beginning and end of each journey of the vehicle, and a means for determining and storing the cumulative distance travelled by the vehicle during each journey is provided. Preferably, a means is provided for determining and storing the time taken for each journey.

In one embodiment of the invention the means for storing and cross-referencing the time with the locations of the vehicle stores the relevant date.

Preferably, the apparatus monitors the vehicle for a monitoring period. Advantageously, the apparatus monitors the vehicle for a monitoring period of predetermined time.

In one embodiment of the invention the predetermined monitoring intervals are monitoring intervals of predetermined time.

In another embodiment of the invention a comparing means is provided for comparing each determined value of vehicle speed with a reference minimum speed value, and the vehicle speed storing means stores only those vehicle speed values which exceed the reference minimum speed value. Preferably, the reference minimum speed value is the lowest value of maximum allowed speeds in respective speed limit zones of a jurisdiction in which the movement of the vehicle is being monitored.

In another embodiment of the invention a means for determining and storing the vehicle speed in excess of the maximum allowed speed for each location for which an infringement is recorded is provided. Advantageously, a means is provided for determining and storing the maximum excess speed over the maximum allowed speed for each speed limit zone. Preferably, a means is provided for determining and storing the average excess speed over the maximum allowed speed for each speed limit zone. Advantageously, a means is provided for determining and storing the number of times the vehicle is monitored.

In one embodiment of the invention a means for determining and storing the number of infringements as a ratio of the number of times the vehicle is monitored is provided.

In another embodiment of the invention a means for determining and storing the number of infringements in each speed limit zone as a ratio of the number of times the vehicle is monitored in the corresponding speed limit zone is provided.

In a further embodiment of the invention a means is provided for computing and storing a score for ranking the quality of driving of the driver of the vehicle as a function of the number of infringements recorded.

In another embodiment of the invention a means is provided for weighting at least some of the infringements for determining the score.

In a further embodiment of the invention a means is provided for generating a report on the quality of the driving of the driver of the vehicle.

In one embodiment of the invention a means is provided for comparing the times at which the vehicle is determined as moving with a reference time period during which the vehicle should not be moving, and a means is provided for making a record of movements of the vehicle during time periods during which the vehicle should not be moving in the report. Preferably, the means for determining the locations and speeds of the vehicle comprises a first computing means located in the vehicle, and the means for storing the locations and speeds of the vehicle comprises a storing means located in the vehicle, and the locations and speeds are stored in the storing means for subsequent transmission to a central monitoring station. Advantageously, the means for comparing the vehicle speed with the reference minimum speed value is provided by the first computing means in the vehicle. Preferably, the means for comparing the vehicle speeds with the corresponding maximum allowed speeds of the respective speed limit zones comprises a second computing means at the central monitoring station.

In one embodiment of the invention the first computing means transmits the stored data in the storing means in the vehicle to the central monitoring station at the end of each monitoring period. Preferably, the first computing means is responsive to an interrogation signal transmitted by the central monitoring station for transmitting the data stored in the storing means in the vehicle to the second computing means in the central monitoring station.

In one embodiment of the invention the second computing means stores a map of the jurisdiction in which the vehicle is being monitored, the map having areas of speed limit zones of different maximum allowed speeds identified thereon, and the maximum allowed speed of each determined location is determined by looking up the map.

Preferably, the speed zones are defined by boundaries, and a plurality of longitude and latitude co-ordinates defining each boundary are stored.

Advantageously, the maximum allowed speed of each determined location is determined by comparing the longitude and latitude co-ordinates of the determined location with the stored longitude and latitude co-ordinates of the boundaries of the respective speed limit zones on the map for determining the speed limit zone within which the determined location is located.

In one embodiment of the invention the map is electronically stored.

In another embodiment of the invention the means for determining the location of the vehicle comprises a GPS monitoring means.

In a further embodiment of the invention the means for storing each location of the vehicle stores the respective locations there of by their longitude and latitude co-ordinates.

In a further embodiment of the invention the storing means for storing the particulars of movement of the vehicle store the particulars electronically.

The advantages of the invention are many. The method and apparatus for monitoring the movement of a vehicle are particularly suitable for permitting a determination to be made as to the quality of the driving of a driver of the vehicle. By virtue of the fact that the location and speed of the vehicle are determined at predetermined monitoring intervals, once these monitoring intervals are kept relatively short, a particularly good profile of the driving of the driver of the vehicle can be prepared. While the monitoring intervals may be any suitable intervals, in general, it is desirable that they should be relatively short, and preferably, of less than sixty seconds' duration, and ideally, less than thirty seconds' duration, and preferably, of approximately ten seconds' duration.

A particularly important advantage of the invention is achieved when the method and apparatus determines and assigns a score to the driving of the driver, particularly where the score takes into account the number of infringements in the different speed limit zones, and in particular, the amount by which the speed infringements exceed the maximum allowed speeds of the respective speed limit zones, and furthermore, by virtue of the fact that the score takes into account the average amount by which the driver exceeds the maximum allowed speeds of the respective speed limit zones. By weighting the infringements depending on the number of infringements, the number of infringements in the respective speed limit zones, the amounts by which the maximum speeds exceed the maximum allowed speeds in the respective speed limit zones, and in particular, weighting the maximum excess speeds in the higher speed limit zones a particularly accurate score for rating the quality of the driver is determined. Furthermore, by weighting the average amount by which the respective maximum allowed speeds of the speed limit zones are exceeded and by weighting these by a greater amount in the higher speed zones, an even more accurate score of the ranking of the driving of the driver can be achieved.

By providing the apparatus for monitoring the location of the vehicle and the speed of the vehicle on-board the vehicle, and determining the location of the vehicle by use of the GPS system, a particularly advantageous form of apparatus is provided. Additionally, by using the GPS system to determine the speed of the vehicle a particularly convenient construction of apparatus is provided. An advantage of using the GPS system to determine the speed of the vehicle is that the amount of calibration of the apparatus required when being fitted to a motor vehicle is minimised.

By only recording the speed of the vehicle at locations where the speed exceeds the minimum value of the maximum allowed speeds of the respective speed limit zones, a particularly convenient form of the apparatus is provided in that on-board storage space in the vehicle is minimised, and the transmission of data from the apparatus on-board the vehicle to the central monitoring station is minimised.

Additionally, by providing the comparison and computing means for determining if the driver has exceeded the maximum allowed speeds of the respective speed limit zones in the central monitoring station, a particularly optimised form of the apparatus is provided, since the computations and determination of the respective excess values of speed can readily easily be carried out in the central monitoring station where adequate processing power can be provided more easily than on-board a motor vehicle.

The invention will be more clearly understood from the following description of a preferred embodiment thereof, which is given by way of example only, with reference to the accompanying drawings, in which:

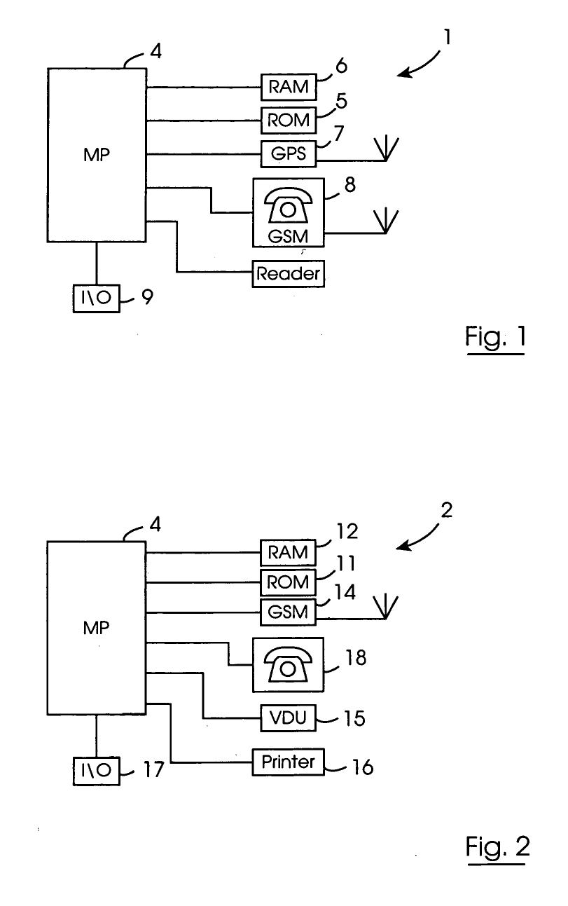

FIG. 1 is a block representation of a part of apparatus according to the invention for monitoring movement of a vehicle,

FIG. 2 is a block representation of another part of the apparatus according to the invention for monitoring movement of a vehicle,

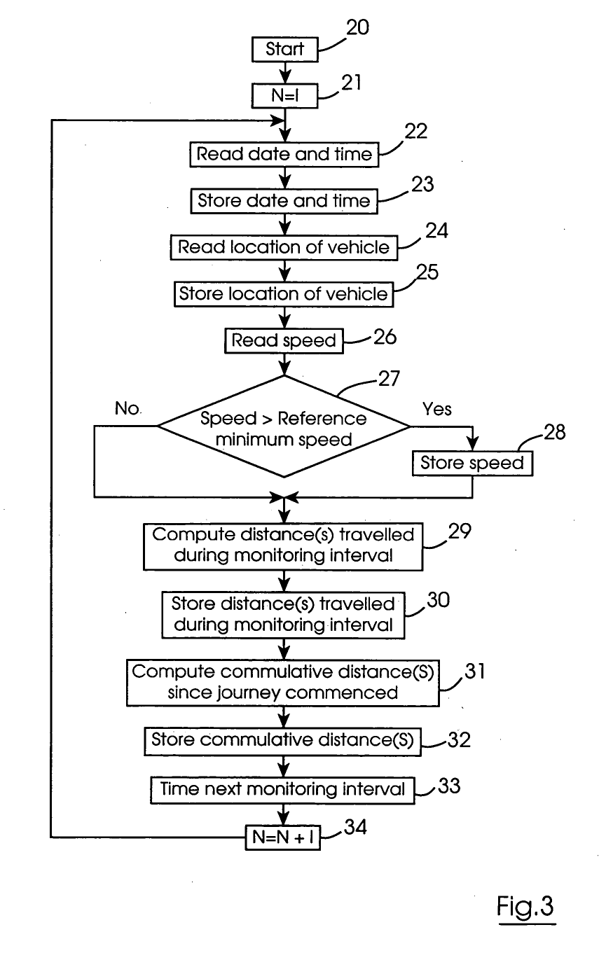

FIG. 3 is a flow chart of the operation of the apparatus of FIG. 1,

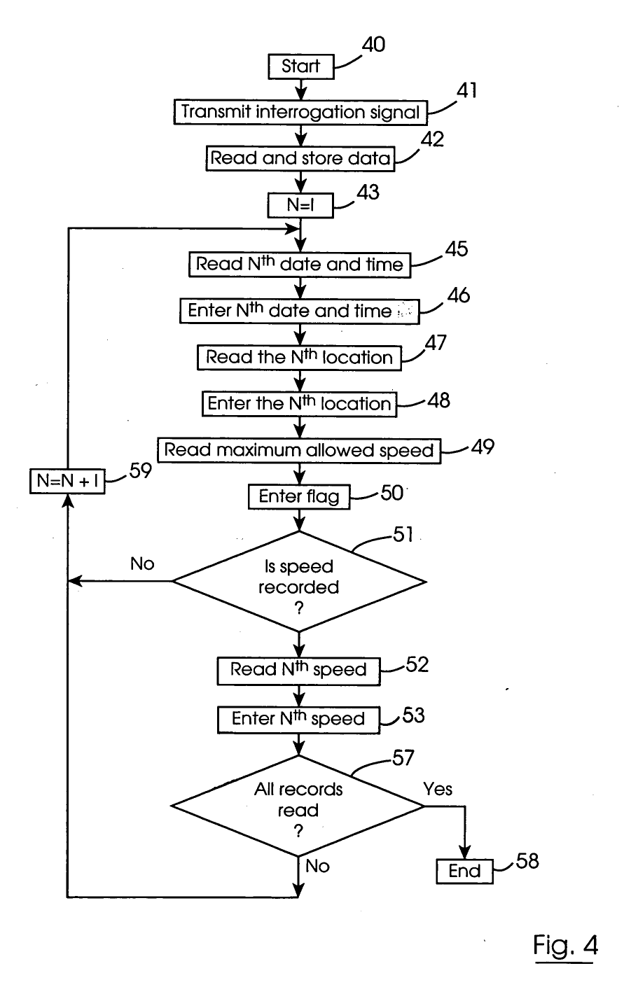

FIG. 4 is a flow chart illustrating part of the operation of the apparatus of FIG. 2,

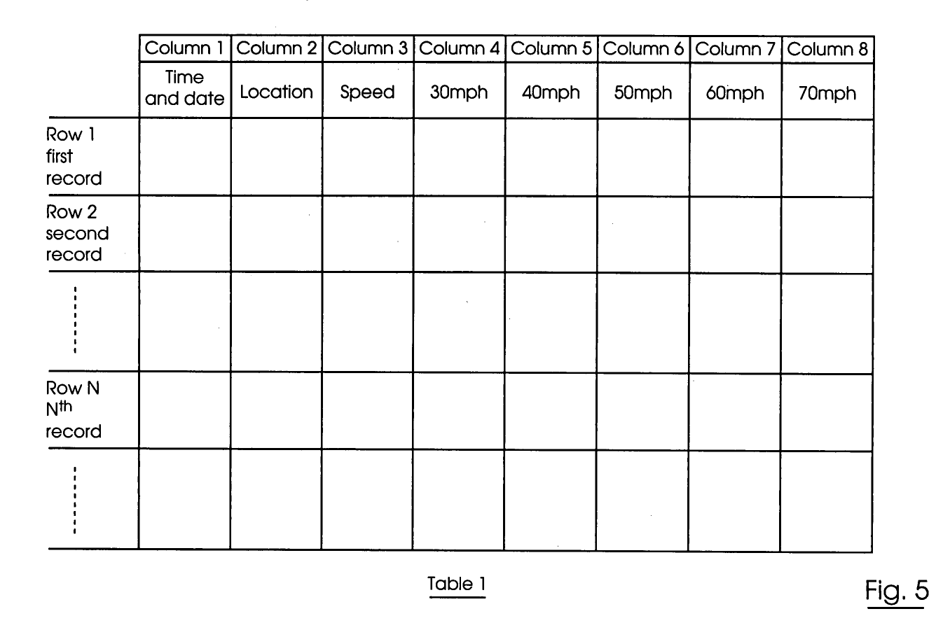

FIG. 5 is a representation of a Table 1 prepared by the apparatus of FIG. 2,

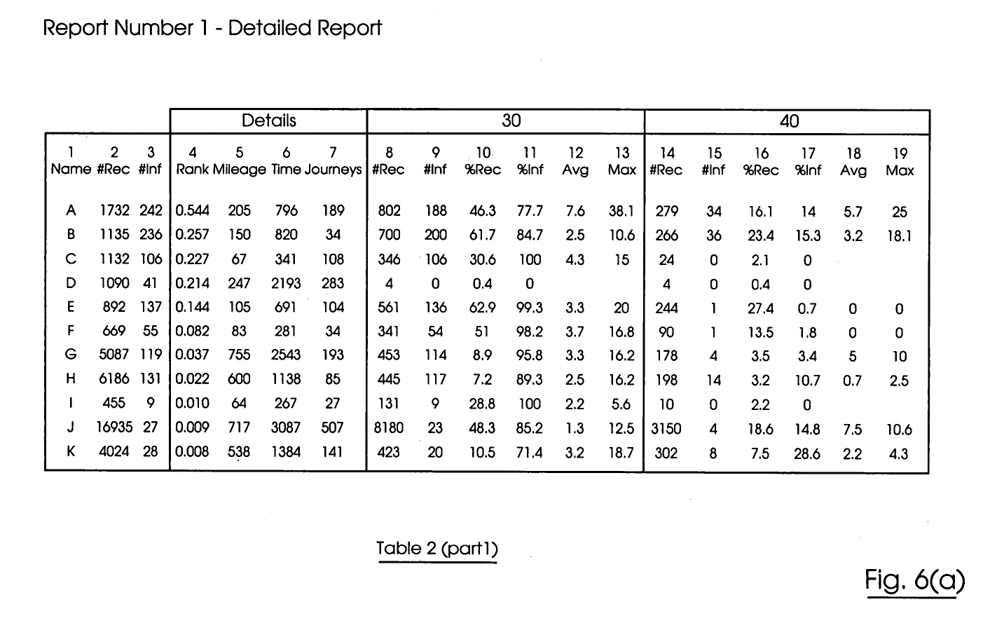

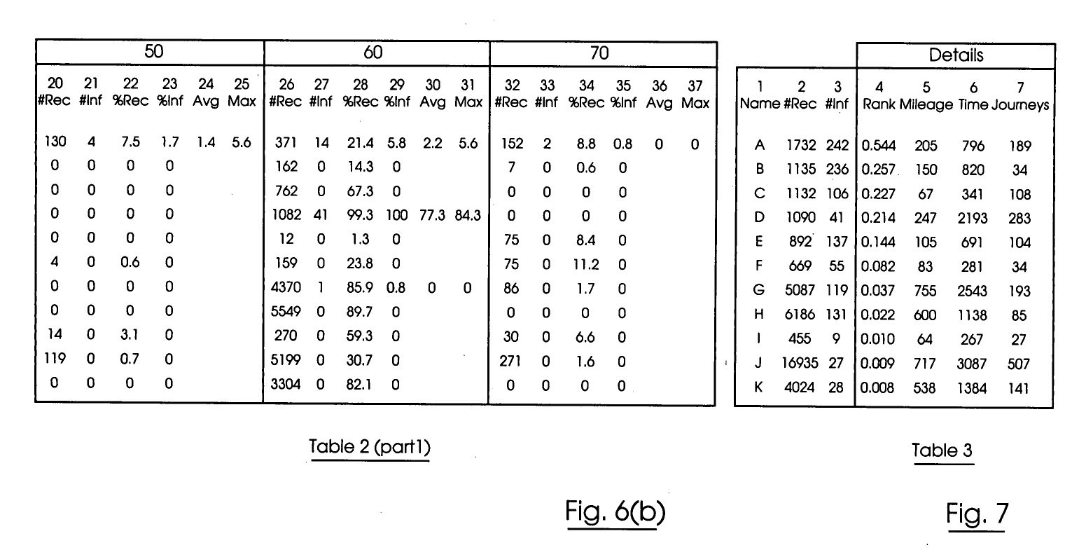

FIG. 6(a) and (b) is a representation of a Table 2 also prepared by the apparatus of FIG. 2, and

FIG. 7 is another representation of a Table 3 prepared by the apparatus of FIG. 2.

Referring to the drawings, there is illustrated apparatus according to the invention for monitoring movement of a vehicle, in this embodiment of the invention a motor vehicle, such as, for example, a car, and also for determining the quality of driving of the driver of the vehicle. The apparatus according to the invention comprises a monitoring apparatus, indicated generally by the reference numeral 1, which is illustrated in FIG. 1, and which is mounted on-board the vehicle for monitoring the movement of the vehicle, and the apparatus according to the invention also comprises a server, indicated generally by the reference numeral 2, which is located in a central monitoring station, and which communicates with the monitoring apparatus 1 for receiving data from the apparatus 1 for in turn facilitating a determination of the quality of the driving of the driver of the vehicle.

Before describing the monitoring apparatus 1 and the server 2 in detail, a brief outline of the method according to the invention for monitoring the movement of the vehicle, and in turn determining the quality of driving of the driver of the vehicle will first be described. The monitoring apparatus 1 uses the global positioning system (GPS) system for determining the location of the vehicle and the speed of the vehicle at monitoring intervals of predetermined time, in this embodiment of the invention the monitoring of the vehicle is carried out at ten-second monitoring intervals. The location of the vehicle each time the vehicle is monitored is stored with reference to the longitude and latitude co-ordinates of the location as determined by the GPS system, and the corresponding times and dates at which the locations of the vehicle are determined are stored and cross-referenced with the corresponding locations.

The speed of the vehicle at each location at the end of each monitoring interval is read from the GPS system. The monitoring apparatus 1 determines if the speed of the motor vehicle is greater than a reference minimum speed, namely, the minimum one of the maximum allowed speeds of the various speed limit zones, and if not, the speed is not recorded. This is on the ground that if the speed of the vehicle is not exceeding the lowest of the maximum allowed speeds of all the speed limit zones, then a speed infringement of the maximum allowed speeds of the various speed limit zones could not occur. Typically, the lowest of the maximum allowed speeds is thirty miles per hour, and thus the reference minimum speed is set at thirty miles per hour. Thus, if the computed speed of the motor vehicle does not exceed thirty miles per hour, the speed of the vehicle is not recorded. However, all speeds above thirty miles per hour are recorded. The computed speeds which exceed thirty miles per hour are recorded and stored in the monitoring apparatus 1 and are cross-referenced with the corresponding dates and times and the locations at which the speeds were recorded for subsequent downloading to the server 2.

At the end of a monitoring period, which may be a period of, for example, one week or less, in response to an interrogation signal transmitted by the server 2 to the monitoring apparatus 1 the monitoring apparatus 1 downloads all the stored data which was stored during the monitoring period. The server 2 then operates on and analyses the data and prepares reports in tabular form which are illustrated in FIGS. 6 and 7, which permit a determination of the quality of the driving of the driver to be made. These reports are described in detail below.

Referring now to FIG. 1, the monitoring apparatus 1 comprises a first computing means, namely, a microprocessor 4 which controls the operation of the monitoring apparatus 1, and which also determines the speed and other relevant parameters of the movement of the vehicle. A first storing means, which comprises a read-only memory (ROM) 5 stores a computer programme under which the microprocessor 4 operates, and which is described below. The lowest value of the maximum allowed speeds of the speed limit zones, namely, thirty miles per hour is also stored in the ROM 5. The first storing means also comprises a random access memory (RAM) 6, which stores the locations of the vehicle and the dates and times at which the vehicle was at the respective locations cross-referenced with the locations, as well as the speeds of the vehicle where the speed of the vehicle exceeded thirty miles per hour. The speeds of the vehicle stored in the RAM 6 are cross-referenced with their respective corresponding locations.

A GPS card 7 communicates with the GPS system at the end of each monitoring interval for determining the location and speed of the vehicle. The longitudinal and lateral co-ordinates of the vehicle determined by the GPS card 7 are read by the microprocessor 4 under the control of the computer programme stored in the ROM 5 and are stored in the RAM 6. The locations of the vehicle are stored by way of their longitude and latitude co-ordinates. The microprocessor 4 reads the speed of the vehicle from the GPS card 7 at the end of each monitoring interval. The microprocessor 4 then compares the speed with the stored lowest speed limit value of the jurisdiction namely, thirty miles per hour, which is stored in the ROM 5. If the speed exceeds thirty miles per hour, the speed is stored in the RAM 6 by the microprocessor 4 and is cross-referenced with the corresponding location of the vehicle. The microprocessor 4 computes the distance travelled by the vehicle during each monitoring interval by computing the average speed of the vehicle during the monitoring interval and multiplying the average speed by the time duration of the monitoring interval, namely, ten seconds. The average speed is computed from the speed read at the end of the monitoring interval and the previously read speed which is the speed which was read at the beginning of the monitoring interval. The distance travelled during each monitoring interval is stored in the RAM 6 and cross-referenced with the location at the end of the monitoring interval.

A communicating means, namely, a general short messaging (GSM) card 8, which may also be provided by a mobile phone, is operated under the control of the microprocessor 4 for communicating with the server 2 at the central monitoring station, as will be described below. The data stored in the RAM 6 relevant to the movement of the vehicle is downloaded to the server 2 through the GSM card 8 at the end of each monitoring period, as will be described below.

An I/O port 9 is provided to the microprocessor 4 for also facilitating downloading of data from the RAM 6 of the monitoring apparatus 1, and for programming the apparatus 1.

Referring now to FIG. 2, the server 2 comprises a second computing means, namely, a microprocessor 10 which controls the operation of the server 2. A second storing means which comprises a read-only memory (ROM) 11 stores a computer programme under which the microprocessor 10 operates, and which is described below. The second storing means also comprises a random access memory (RAM) 12, which stores downloaded data from the monitoring apparatus 1, and also the reports which are prepared by the microprocessor 10. A communicating means comprising a GSM card 14, which may also be provided by a mobile phone, communicates with the GSM card 8 of the monitoring apparatus 1 for downloading the data from the monitoring apparatus 1. A visual display unit 15 is provided for displaying data and reports compiled and computed by the microprocessor 10. The compiled reports are printed out on a printer 16. An I/O port 17 to the microprocessor 10 provides for the inputting and outputting of data from the microprocessor 10, and for programming the server 2. A land line telephone 18 communicating with the microprocessor 10 is also provided for communicating with the monitoring apparatus 1.

The ROM 11 as well as storing the computer programme under which the microprocessor 10 operates, also stores one or more maps in electronic form of the jurisdiction in which the vehicle is being monitored. The maps which are stored in the ROM 11 in electronic form indicate the maximum allowed speed in the respective speed limit zones in the jurisdiction. The areas of the respective speed limit zones are identified by boundaries, and the boundaries of the respective speed limit zones are stored as series of longitude and latitude co-ordinates for facilitating ready identification of the maximum allowed speed of any location on the map within the jurisdiction. Such maps stored in electronic form with such information regarding speed limit zones will be known to those skilled in the art.

Referring now to FIG. 3, a flow chart of the computer programme stored in the ROM 5 of the monitoring apparatus 1 under which the microprocessor 4 operates will now be described. Block 20 starts the computer programme, and the computer programme moves to block 21. Block 21 sets N=1. N represents the number of times the vehicle is monitored during the current monitoring periods. The computer programme then moves to block 22, which reads the date and time and moves to block 23 which stores the date and time in the RAM 6. The computer programme then moves to block 24. Block 24 reads the location of the vehicle from the GPS card 7. The computer programme then moves to block 25 which stores the location of the vehicle in the RAM 6 cross-referenced with the date and time stored by block 23. The computer programme then moves to block 26 which reads the speed of the vehicle from the GPS card 7, and moves to block 27.

Block 27 checks if the speed is greater than the reference minimum speed, namely, greater than thirty miles per hour. If block 27 determines that the speed is greater than the reference minimum speed, the computer programme moves to block 28, which stores the speed in the RAM 6 cross-referenced with the corresponding location which was stored by block 25. The computer programme then moves to block 29, which will be described below. If block 27 determines that the speed is not greater than the reference minimum speed, the computer moves directly to block 29.

Block 29 computes the distance s travelled during the monitoring interval. This is computed as described above by averaging the speed of the vehicle just stored by block 28 and the speed which was read on the immediately preceding pass, which was temporarily stored by the computer programme, and multiplying the computed average speed by the time duration of the monitoring interval, namely, ten seconds. The computer programme then moves to block 30 which stores the computed distance s travelled during the monitoring interval in the ram 6 cross-referenced with the location of the vehicle stored by block 25. The computer programme then moves to block 31. Block 31 computes the cumulative distance S travelled by the vehicle since the journey commenced, and the computer programme moves to block 32 which stores the cumulative distance S in the RAM 6 cross-referenced with the location of the vehicle stored by block 25.

The computer programme then moves to block 33 which times the next monitoring interval. On the next monitoring interval having been timed out, the computer programme moves to block 34 which increments N by one, and returns the computer programme to block 22 to commence the next pass of the computer programme for carrying out the next monitoring of the vehicle. Thus, at the end of each pass of the computer programme the date, time, location and speed of the vehicle are stored in the RAM 6 at the end of the corresponding monitoring interval. In addition, the distance travelled by the vehicle during each monitoring interval, and the cumulative distance travelled by the vehicle since the commencement of a journey are also stored in the RAM 6 at the end of each monitoring interval. The date, time, location, speed and the respective distances are all cross-referenced and correlated with each other in the RAM 6.

Before preparing the reports illustrated in FIGS. 6 and 7, the server 2 tabulates the data after downloading it from the monitoring apparatus 1 at the end of each monitoring period. The data is tabulated in the form of Table 1, which is illustrated in FIG. 5 by a subroutine of the computer programme stored in the ROM 11. Referring now to FIG. 4, the subroutine of the computer programme under which the microprocessor 10 of the server 2 operates in order to tabulate the data in the form of Table 1 will now be described. Block 40 starts the subroutine, which moves to block 41. Block 41 transmits an interrogation signal through the GSM card 14 of the server 2 to the GSM card 8 of the monitoring apparatus 1 with an instruction to download the data for the monitoring period from the RAM 6 in the monitoring apparatus 1. The subroutine then moves to block 42 which reads the data being downloaded from the monitoring apparatus 1 and stores the data in the RAM 12. The subroutine then moves to block 43 which sets N equal to one. N represents the number of each record stored by the computer programme of FIG. 3. In other words, the first time the vehicle is monitored during the monitoring period is deemed to be the first record, and at the end of the first monitoring interval the movement of the vehicle is again monitored, and that is deemed to be the second record. After the second monitoring interval the third record of the movement of the vehicle is made, and so on. The subroutine then moves to block 45 which reads the date and time of the Nth record from the RAM 12, which on the first pass of the subroutine is the first record, and so on. The subroutine then moves to block 46 which enters the read date and time in the Nth row of column 1 of Table 1. Thus, in the case of the first pass of the subroutine, the date and time of the first record is entered in row 1 of column 1, and so on for the second and subsequent records.

The subroutine then moves to block 47 which reads the location of the vehicle at the Nth record, and moves to block 48 which enters the location of the vehicle of the Nth record in row N of column 2 of Table 1. The subroutine then moves to block 49 which determines from the map stored in the ROM 11 the maximum allowed speed for the location of the Nth record. The subroutine moves to block 50 which enters a flag in the Nth row in the appropriate one of columns 4 to 7 corresponding to the maximum allowed speed limit zone of the location of the Nth record. The subroutine then moves to block 51 which checks has a speed value been stored for the Nth record and if so, moves to block 52 which reads the speed of the Nth record. Block 53 of the subroutine enters the speed of the Nth record in the Nth row in the third column of Table 1. In this embodiment of the invention it is envisaged that the jurisdiction will include five different speed limit zones. The lowest speed limit zone is the thirty mile per hour speed limit zone. The remaining four speed limit zones are forty mile per hour, fifty mile per hour, sixty mile per hour and seventy mile per hour speed limit zones, respectively. Column 4 relates to the thirty mile per hour speed limit zone, while Column 5 relates to the forty mile per hour speed limit zone. Columns 6, 7 and 8 relate to the fifty mile per hour, sixty mile per hour and seventy mile per hour speed limit zones, respectively. Thus, when a location of the vehicle is determined as being in a thirty mile per hour speed limit zone a flag for that record is set in the thirty mile per hour speed limit zone, and so on for the forty mile per hour, fifty mile per hour, sixty mile per hour and seventy mile per hour speed limit zones, respectively.

The subroutine then moves to block 57 which checks if all records for the monitoring period have been read, and if so, the subroutine moves to block 58 which ends the subroutine and returns control of the microprocessor to the main computer programme stored in the ROM 11. Should block 57 determine that all the records of the monitoring period have not yet been read, the subroutine moves to block 59 which increments N by one and returns the subroutine to block 45. If block 51 determines that no speed value has been stored for the Nth record the subroutine moves to block 59 which has already been described.

When all N records have been read, the compilation of Table 1 is complete. The computer programme stored in the ROM 11 next commences the preparation of the detailed report of Table 2 of FIG. 6.

The report of Table 2 is a detailed report, and contains corresponding data on a number of drivers, namely, drivers A to K which are listed in Column 1 of the report of Table 2. The server 2 in the central monitoring station receives similar type data from a large number of monitoring apparatus similar to the monitoring apparatus 1 which are located in a plurality of vehicles, all of which are being monitored by the server at the central monitoring station. Thus, the server 2 under the control of the computer programme stored in the ROM 11 in preparing the detailed report of Table 2 prepares the report for a number of drivers whose driving is being monitored on behalf of an insurance company. The detailed report is then submitted to the insurance company.

Columns 2 to 7 of the detailed report of Table 2 contain the most important information for facilitating a determination of the quality of the driving of the respective individuals, and this information is prepared and contained in a summarised report which is illustrated in FIG. 7 and identified as Table 3. Columns 8 to 13 of the detailed report relate to aspects of each of the drivers driving in thirty mile per hour speed limit zones. Columns 14 to 19 of the detailed report contain details of aspects of the drivers driving in forty mile per hour speed limit zones, while Columns 20 to 25 contain similar data in respect of fifty mile per hour speed limit zones. Columns 26 to 31 contain similar data relating to sixty mile per hour speed limit zones, while Columns 32 to 37 contain similar data relating to seventy mile per hour speed zones.

The computer programme initially reads the name of the driver which is downloaded from the monitoring apparatus 1 and stored in the RAM 2 and enters the name of the driver in column 1 of Table 2. The computer programme then reads the number of records from column 1 of Table 1 made during the monitoring period for the relevant driver, and enters this in column 2 of Table 2 for the relevant driver. The computer programme then reads the total mileage travelled by the vehicle during the monitoring period from the RAM 12, and enters this in column 5 of Table 2. The total time during which the vehicle was being driven during the monitoring period is read from the RAM 12, and entered in column 6. The total time during which the vehicle is driven during the monitoring period is also recorded by the monitoring apparatus 1 and stored in the RAM 6, and is thus downloaded with the data to the server 2 at the end of the monitoring period.

The computer programme then reads the number of journeys made by the vehicle during the monitoring period from the RAM 12 and enters this in column 7 of Table 2. The computer programme then counts the number of flags in column 4 of Table 2, which is the column corresponding to the 30 mile per hour speed zone, and enters the number of flags in column 8 of Table 2. The number of flags in Column 4 of Table 1 corresponds to the number of records made of the vehicle in a 30 mile per hour zone. The computer programme then computes the speed in excess of 30 miles per hour of the vehicle for each infringement of the 30 mile per hour speed limit and from this computes the average speed in excess of the 30 mile per hour speed limit. The average speed is entered in column 12 of Table 2. The computer programme then determines the maximum value by which the 30 mile per hour speed limit was exceeded during the monitoring period, and this value is entered in column 13 of Table 2. The number of infringements of the 30 mile per hour speed limit is computed and entered in column 9 of Table 2. The number of infringements is computed as a percentage of the number of records made of the vehicle in 30 mile per hour zones, and this is entered in column 11 of Table 2. The number of records of the vehicle made in 30 mile per hour zones is computed as a percentage of the total number of records entered in column 2 of Table 2 and the percentage is entered in column 10 of Table 2.

The computer programme computes similar values of number of records in 40 mile per hour speed limit zones, number of infringements in 40 mile per hour speed limit zones, the percentage of the number of records in the 40 mile per hour zone as a percentage of the total number of records made during the monitoring period as well as the percentage of infringements in the 40 mile per hour zone, the average speed in excess of 40 miles per hour in 40 mile per hour zones, and the maximum speed in excess of 40 miles per hour in 40 mile per hour zones. These are entered in columns 14 to 19 of Table 2. Similar computations are made for 50, 60 and 70 mile per hour speed limit zones, and these are entered in columns 20 to 37 of Table 2. Sample values are shown in Table 2 to assist in understanding the invention.

After the appropriate values have been computed and entered in columns 2, and 5 to 37, the total number of infringements during the monitoring period is entered in column 3. The computer programme then assigns a weighting to the infringements in the different speed zones depending on the speed zone, the average and maximum values of speed by which the vehicle speed exceeded the speed limit of the relevant zone. Higher weightings are assigned to the infringements which take place in the higher value speed zones and also to the higher average and maximum values by which the respective speeds are exceeded. After the respective infringements in the respective zones have been appropriately weighted, a score or ranking value is assigned to the driver which is derived from the weighted infringements. The lower the ranking value, the higher the quality of driving of the driver. As can be seen, driver K has the lowest ranked score, namely, 0.008, and is thus the best driver, while the driver with the highest ranked score is driver A with a score of 0.544, and is thus the worse driver.

Table 3 of FIG. 7 illustrates a summarised version of the detailed report for drivers A to K which contains only the first seven columns of the detailed report of Table 2.

Some insurance companies may impose a curfew on young drivers, for example, a young driver may be given a preferential rate of insurance if the driver undertakes not to drive between the hours of 23.00 hours and 6.00 hours, and in which case the computer programme of the server 2 would check the times recorded in column 1 of Table 1 to ascertain if the vehicle was moving during such curfew periods. If so, a record of this would also be included in the summarised and detailed report. After assessing the reports of individuals, an insurance company could then determine the quality of driving of the driver, and set the insurance premium for each driver in accordance with the quality of the driver.

What is claimed is:

1-90. (Canceled)

91. A method for monitoring movement of a vehicle, the method comprising the steps of determining the location of the vehicle at predetermined monitoring intervals, and determining the speed of the vehicle at each monitoring interval, characterized in that, at least some of the determined speeds of the vehicle are stored and cross-referenced with the corresponding locations, maximum allowed speeds are determined for the respective locations for which vehicle speeds are stored, the stored vehicle speeds are compared with the corresponding maximum allowed speeds for the respective locations, and an infringement is recorded and stored and cross-referenced with each location at which the vehicle speed exceeded the maximum allowed speed.

92. A method as claimed in claim 91 characterized in that the time at which each monitoring of the vehicle is carried out is stored, and each location of the vehicle at which the vehicle is monitored is stored and cross-referenced with the corresponding stored time at which the vehicle is monitored, and the distance traveled by the vehicle during each monitoring interval is determined and stored and cross-referenced with the corresponding stored time corresponding to the end of the monitoring interval.

93. A method as claimed in claim 92 characterized in that the beginning and end of each journey of the motor vehicle is identified, and the cumulative distance traveled by the vehicle during each journey is determined and stored, and the time taken for each journey is determined and stored.

94. A method as claimed in claim 91 characterized in that the vehicle is monitored for a monitoring period of predetermined time, and the predetermined monitoring intervals are monitoring intervals of predetermined time.

95. A method as claimed in claim 91 characterized in that each determined value of vehicle speed is compared with a reference minimum speed value, and only those vehicle speed values which exceed the reference minimum speed value are stored, and the reference minimum speed value is the lowest value of maximum allowed speeds in respective speed limit zones of a jurisdiction in which the movement of the vehicle is being monitored, and the maximum excess speed over the maximum allowed speed for each speed limit zone is determined and stored, and the average excess speed over the maximum allowed speed for each speed limit zone is determined and stored and cross-referenced with the corresponding speed limit zone.

96. A method as claimed in claim 91 characterized in that the number of times the vehicle is monitored during the monitoring period is determined and stored, and the number of infringements as a ratio of the number of times the vehicle is monitored is determined and stored, and preferably, the number of infringements in each speed limit zone as a ratio of the number of times the vehicle is monitored in the corresponding speed limit zone is determined and stored, and advantageously, a score for ranking the quality of driving of the driver of the vehicle is computed as a function of the number of infringements recorded, and the computed score stored, and preferably, at least some of the infringements are weighted for determining the score.

97. A method as claimed in claim 96 characterized in that a report on the quality of the driving of the driver of the vehicle is generated, and the report comprises particulars of the driver driving the vehicle, particulars of the vehicle, and the driver's score.

98. A method as claimed in claim 91 characterized in that the location and speed of the vehicle are determined by a computing means located in the vehicle and are stored in a storing means located in the vehicle for subsequent transmission to a central monitoring station, and the comparison of the vehicle speed with the reference minimum speed value is carried out in the computing means in the vehicle, and the comparisons of the vehicle speeds with the corresponding maximum allowed speeds of the respective speed limit zones are made by a computing means at the central monitoring station.

99. A method as claimed in claim 98 characterized in that the stored data in the storing means in the vehicle is transmitted to the central monitoring station at the end of each monitoring period, and/or the data stored in the storing means in the vehicle is downloaded to the central monitoring station in response to an interrogation signal transmitted to the vehicle from the central monitoring station.

100. A method as claimed in claim 98 characterized in that a map of the jurisdiction in which the vehicle is being monitored is stored in the central monitoring station, the map having areas of speed limit zones of different maximum allowed speeds identified thereon, and the maximum allowed speed of each determined location is determined by looking up the map.

101. A method as claimed in claim 91 characterized in that the location of the vehicle is determined from a GPS monitoring system.

102. A method as claimed in claim 101 characterized in that the distance traveled by the vehicle during each monitoring interval is computed by computing the average speed of the vehicle at the beginning and at the end of the corresponding monitoring interval, and multiplying the computed average speed by the time of the monitoring interval.

103. Apparatus for monitoring movement of a vehicle, the apparatus comprising a means for determining the location of the vehicle at predetermined monitoring intervals, and a means for determining the speed of the vehicle at each monitoring interval, characterized in that, the apparatus comprises a means for storing at least some of the determined speeds of the vehicle and for cross-referencing the vehicle speeds with the corresponding locations, a means for determining maximum allowed speeds for the respective locations for which vehicle speeds are stored, a means for comparing the stored vehicle speeds with the corresponding maximum allowed speeds for the respective locations, and a means for recording and storing an infringement and for cross-referencing the infringement with each corresponding location at which the vehicle speed exceeded the maximum allowed speed.

104. Apparatus as claimed in claim 103 characterized in that a means for storing the times at which the vehicle is monitored is provided, and a means for storing each location of the vehicle at which the vehicle is monitored and cross-referenced with the corresponding stored time at which the vehicle was monitored is provided, and a means is provided for determining and storing the distance traveled by the vehicle during each monitoring interval cross-referenced with the corresponding stored time corresponding to the end of the monitoring interval, and a means is provided for identifying the beginning and end of each journey of the vehicle, and a means for determining and storing the cumulative distance travelled by the vehicle during each journey is provided.

105. Apparatus as claimed in claim 103 characterized in that the apparatus monitors the vehicle for a monitoring period of predetermined time, and the predetermined monitoring intervals are monitoring intervals of predetermined time.

106. Apparatus as claimed in claim 103 characterized in that a comparing means is provided for comparing each determined value of vehicle speed with a reference minimum speed value, and the vehicle speed storing means stores only those vehicle speed values which exceed the reference minimum speed value.

107. Apparatus as claimed in claim 103 characterized in that a means is provided for determining and storing the number of times the vehicle is monitored, and a means for determining and storing the number of infringements as a ratio of the number of times the vehicle is monitored is provided, and a means is provided for computing and storing a score for ranking the quality of driving of the driver of the vehicle as a function of the number of infringements recorded, and advantageously, a means is provided for weighting at least some of the infringements for determining the score.

108. Apparatus as claimed in claim 107 characterized in that a means is provided for generating a report on the quality of the driving of the driver of the vehicle.

109. Apparatus as claimed in claim 103 characterized in that a means is provided for comparing the times at which the vehicle is determined as moving with a reference time period during which the vehicle should not be moving, and a means is provided for making a record of movements of the vehicle during time periods during which the vehicle should not be moving in the report, and the means for determining the locations and speeds of the vehicle comprises a first computing means located in the vehicle, and the means for storing the locations and speeds of the vehicle comprises a storing means located in the vehicle, and the locations and speeds are stored in the storing means for subsequent transmission to a central monitoring station, and the means for comparing the vehicle speed with the reference minimum speed value is provided by the first computing means in the vehicle, and the means for comparing the vehicle speeds with the corresponding maximum allowed speeds of the respective speed limit zones comprises a second computing means at the central monitoring station.

110. Apparatus as claimed in claim 109 characterized in that the first computing means transmits the stored data in the storing means in the vehicle to the central monitoring station at the end of each monitoring period, and the first computing means is responsive to an interrogation signal transmitted by the central monitoring station for transmitting the data stored in the storing means in the vehicle to the second computing means in the central monitoring station, and the second computing means stores a map of the jurisdiction in which the vehicle is being monitored, the map having areas of speed limit zones of different maximum allowed speeds identified thereon, and the maximum allowed speed of each determined location is determined by looking up the map.

111. Apparatus as claimed in claim 103 characterized in that the means for determining the location of the vehicle comprises a GPS monitoring means.
